(19) United States
(12) Patent Application Publication
(10) Pub. No.: US 2025/0347331 A1
(43) Pub. Date: Nov. 13, 2025

(54) REFINED BRAKE DISK

(71) Applicant: BERINGER AERO, TALLARD (FR)

(72) Inventor: Gilbert Beringer, Fouillouse (FR)

(73) Assignee: Beringer Aero, Tallard (FR)

(21) Appl. No.: 18/730,034

(22) PCT Filed: Oct. 24, 2022
(86) PCT No.: PCT/FR2022/052009

§ 371 Date: Jan. 16, 2025

(30) Foreign Application Priority Data
Jan. 31, 2022 (FR) FR2200827

(51) Int. Cl. F16D 65/12; F16D 55/22; F16D 65/095

(52) U.S. Cl. CPC F16D 65/125; F16D 55/22; F16D 65/095; F16D 2200/0021; F16D 2200/0052

(57) ABSTRACT

The invention concerns a disc (40) for a disc brake (30).

According to the invention, the disc (40) is made of steel containing less than 0.3% by weight of Carbon.

### TECHNICAL FIELD

The invention relates to the technical field of disc brakes, and particularly to the discs used in such brakes.

### PRIOR ART

In the field of disc brakes, braking force is directly related to parameters such as:
The material of the brake pads;
The material of the disc;
The area of the friction zone of the pads on the disc;
The clamping force of the pads on the disc.

The performance of the braking, on the other hand, is related to factors including:
The obtainable braking force;
Kinetic parameters such as the rotational speed of the disc, the kinetic energy of the vehicle carrying the brake in question, and especially the kinetic energy to be dissipated during each braking;
The frequency of brake use over time;
The thermal parameters of the brake, including its ability to withstand the heat generated during the conversion of kinetic energy into thermal energy, or to dissipate this heat.

Discs are subjected to significant friction from the pads. While the pads are wear parts that are easy to replace, the replacement of a disc is more complicated. The usual tendency is to design wear-resistant discs to extend the interval between replacements. In this case, the often sought-after characteristic is the hardness of the disc.

In the field of motor sports such as motorcycle racing, or in aviation for aircraft landing gear, especially light aircraft, braking is intense and sometimes repeated over a short period. These repeated or intensive brakes lead to a significant increase in the temperature of the pad and disc, which can reach temperatures above 700° C. The temperature rise can be particularly rapid, in just a few seconds.

The high rotational speed of the disc and its flat geometry induce rapid cooling by convection. Such cycles of rapid temperature rises and falls weaken the disc.

Documents WO2019106805A1 and US20110198170A1 describe solutions for lightweight brake pads.

Document CN103952637B describes brake discs made of specific alloys, specifying the content of 13 alloying elements.

Document US20060113008A1 describes brake discs made of highly alloyed alloys.

The article “Les Matériaux De Freinage” by Jacques Raison, published in the July/August 1991 issue of La Revue Générale Des Chemins De Fer, is also known.

### SUMMARY OF THE INVENTION

One of the objectives of the invention is to overcome the drawbacks of the prior art by proposing a brake disc with improved resistance to thermal stress compared to prior art solutions.

To this end, a disc for a disc brake has been developed, notable for being made of steel containing less than 0.3% by weight of carbon, preferably 0.2%, such as case-hardening steel.

This way, the disc has low hardenability. That is, when subjected to rapid temperature drops as mentioned earlier, its crystalline structure will not change as it might with hardenable steel, for example, if it contains more carbon.

It is indeed common to observe that brake discs, during intensive use, are heated to red-hot. Their temperature is thus around 700° C. to 800° C. However, it is recalled that at a temperature above 723° C., the pearlite in steel is entirely transformed into austenite.

Rapid cooling, among other things favored by the convection to which the rotating disc is subjected, is therefore likely to harden the steel, as the carbon in the austenite does not have time to diffuse within the disc: part of the austenite becomes martensite, which is hard but brittle.

This phenomenon also generates internal stresses within the disc.

Avoiding the hardening phenomenon therefore protects the disc.

Moreover, a disc according to the invention is also less subject to thermal fatigue, due to the alternation of material expansions during heating and contractions during cooling. Such a disc thus better withstands intensive and repeated use, for example, in motor sports, particularly in competition.

In one embodiment, the disc is made of 18NiCr5-4 steel. In another embodiment, the disc is made of 16NC6 steel. Both grades contain little carbon and do not harden. However, they have interesting mechanical properties for the considered field. Additionally, these grades correspond to low-alloy steels. Containing few alloying elements, they are simpler to manufacture and thus less expensive.

The invention also concerns a disc brake configured to receive a disc according to the aforementioned characteristics.

Preferably, the brake includes a caliper with pads comprising a support plate receiving a lining, and the support plate is made of low-alloy steel containing less than 0.3% by weight of carbon, preferably less than 0.2%, and vanadium in an amount between 0.2 and 0.3% by weight, with the rest preferably being iron with reasonably foreseeable impurities. The plate is, for example, made of 15CDV6 steel. This grade of steel, usually intended for parts to be welded, nevertheless allows for the creation of a pad with sufficient mechanical and thermal characteristics to obtain a light and resistant pad. The presence of vanadium notably improves the hot strength of the plate. The disc and the pad, more resistant to thermal stress, allow for the design of a higher performance brake, capable of, for example, withstanding greater braking forces.

This particular choice of steel grade allows for the creation of a support plate with a thickness between 2 and 6 mm only, which helps to lighten the pad.

The plate has means for kinematic connection with a brake caliper. In practice, to prevent the pad from deforming, even at high temperature, part of these connection means is configured to withstand greater mechanical forces than the rest of the connection means and takes the form of a reinforced portion. The other part is, on the contrary, lightened.

In a first embodiment, the support plate has a first ear of a first diameter and a second ear of a second diameter larger than the first diameter. Each ear is configured to cooperate respectively with a first bushing and a second bushing of a caliper, creating a sliding connection between the pad and the caliper. The reinforced portion is the second ear. Since the surface of the second ear transmitting the forces is larger, the contact pressure is lower, which prevents galling.

The invention also concerns a caliper comprising a first bushing of a first diameter and a first length, and a second bushing of a second diameter different from the first diameter and a second length different from the first length, the bushings connecting two jaws of the caliper. The caliper receives pads comprising a support plate with a first ear of the first diameter and a second ear of the second diameter, each ear configured to cooperate respectively with the bushings.

In a second embodiment, the support plate has a first ear and a second ear configured to cooperate respectively with bushings of a caliper of identical diameters, creating a sliding connection between the pad and the caliper, and the reinforced portion is an increase in the dimensions of the plate near the second ear.

In this embodiment, the invention also concerns the caliper comprising two bushings of identical diameters connecting two jaws of the caliper; two pads with ears configured to cooperate with the bushings; and a stop. The support plate has an asymmetric part configured to leave a passage for the stop.

### BRIEF DESCRIPTION OF THE DRAWINGS

FIG. 1 is a front view of a disc brake according to the invention.

FIG. 2 is a side view of such a brake.

FIG. 3 is an exploded view of a brake caliper according to the invention.

FIG. 4 is a partial front view of such a caliper.

FIG. 5 is a perspective view of another brake caliper according to the invention.

FIG. 6 is a partial front view of such a caliper.

### DETAILED DESCRIPTION OF THE INVENTION

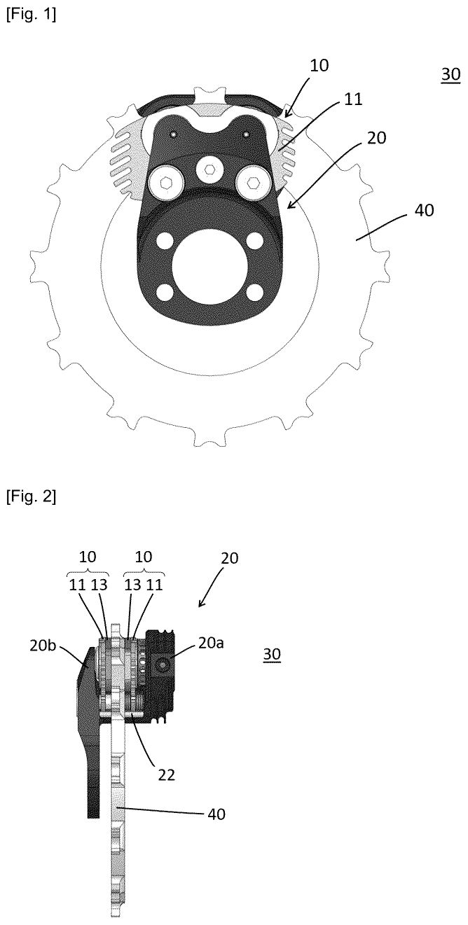

Referring to FIGS. 1 and 2, the invention consists of the brake disc (40) of the brake (30) being made of steel containing less than 0.3% carbon, sometimes called case-hardening steel. Such grades can be, for example, 18NiCr5-4 or 16NC6. Since some alloying elements can improve a material's hardenability, it is clear that the grade should be chosen from an alloy known to reduce hardenability.

The choice of such steel, which has a lower hardness than other materials commonly used to make brake discs, nevertheless allows for a longer lifespan, as discovered by the Applicant.

Indeed, the disc (40) according to the invention is less sensitive to the thermal stresses to which it is subjected, whether these stresses are:
A rise to a temperature above 700° C., then a drop to ambient temperature in less than a few minutes, or even seconds; and/or
High-frequency use of the brake (30), typically 5 to 10 brakes per minute during use in motor sports.

The invention also concerns a brake (30) equipped with such a disc (40). Indeed, the improvements made to the disc (40) push the usage limits of such a brake (30), which can be used more intensively or at higher temperatures.

The brake pads (10) of a brake (30), being subjected to the same temperatures as the disc (40), must also be optimized for the brake (30) to be durable.

In particular, the pads (10) comprise a lining (13) and a support plate (11), and this plate (11) is made of 15CDV6 steel.

Compared to the structural steel usually used to make plates (11), this choice allows for obtaining a plate (11) that is more resistant, both thermally and mechanically. At high temperature, the mechanical strength of the plate (11) is significantly higher.

Specifically, tests were conducted by the Applicant comparing a steel known as “Imex700” or S 690 QL according to the European standard EN 10025-6: March 2005, initially used to make the plate (11), and 15CDV6.

The tests involved bending tests on specimens made of Imex700 and specimens made of 15CDV6. The specimens had identical dimensions, except for the thickness, which was 4 mm for Imex700 and 3 mm for 15CDV6. During the bending test, the specimen is held horizontally and fixed at one end by a clamp, and a weight is suspended from the other end of the specimen. A section of the specimen, near the clamp, was reduced to ensure that the specimen bends at that location. The distance between the free end of the specimen and the reduced section is 150 mm.

The specimen is first tested at a temperature of 21° C. by suspending weights until plastic deformation of the reduced section occurs.

Then a new specimen is tested by suspending weights and heating the reduced section to 600° C. The specimen is then allowed to air cool, and its straightness is checked to determine if the elastic limit was exceeded. The tests are repeated with different weights until the limit between elastic and plastic deformation is found.

The test results are compiled in the table below, noting that given the difference in thickness between the specimens, the induced stress was normalized to account for this difference.

TABLE 1

| | | Bending | Induced | | |
|---|---|---|---|---|---|
| | Thickness | Weight | Stress | | |
| Steel | (mm) | (kg) | (Mpa) | Twisted | Heated |
| 15CDV6 | 3 | 14.06 | 1970 | Yes | 21° C. |
| 15CDV6 | 3 | 7.02 | 984 | Yes | 600° C. |
| 15CDV6 | 3 | 5.6 | 785 | No | 600° C. |
| Imex700 | 4 | 17 | 1340 | Yes | 21° C. |
| Imex700 | 4 | 8.62 | 680 | Yes | 600° C. |
| Imex700 | 4 | 5.82 | 459 | No | 600° C. |

It can be seen that 15CDV6 withstands an induced stress of 785 MPa when heated to 600° C., whereas Imex700 withstands only a stress of 459 MPa. Thus, 15CDV6 is more resistant than Imex700.

It is therefore possible to design a lighter pad (10), notably by reducing the thickness of the plate (11). For example, it measures between 2 mm and 6 mm in thickness only. In practice, it is possible to increase performance at a constant plate thickness or to decrease the plate thickness while maintaining performance. For example, the plate thickness can be reduced from 6 mm to 4.5 mm while maintaining the same performance.

The pad (10) of a brake (30) is a wear part, and its replacement must be easy. Therefore, its mounting, and particularly the kinematic connection linking it to a caliper (20), must be as simple as possible. This connection is generally minimalistic and is ensured by the smallest and simplest possible functional surfaces.

These functional surfaces, which bear the braking force, are generally subjected to galling, or the support plate (11) of the pads (10) may deform. To prevent this, it is often necessary to oversize the pads (10), and particularly their support plates (11).

To ensure that a reduction in thickness does not weaken the kinematic connection surfaces of the pad (10) with the caliper (20), these connection means include a reinforced portion (19).

However, the direction of significant braking forces is always the same, that of the vehicle's forward movement: it is therefore not practical to reinforce the entire kinematic connection means, but only the surfaces that oppose significant braking forces.

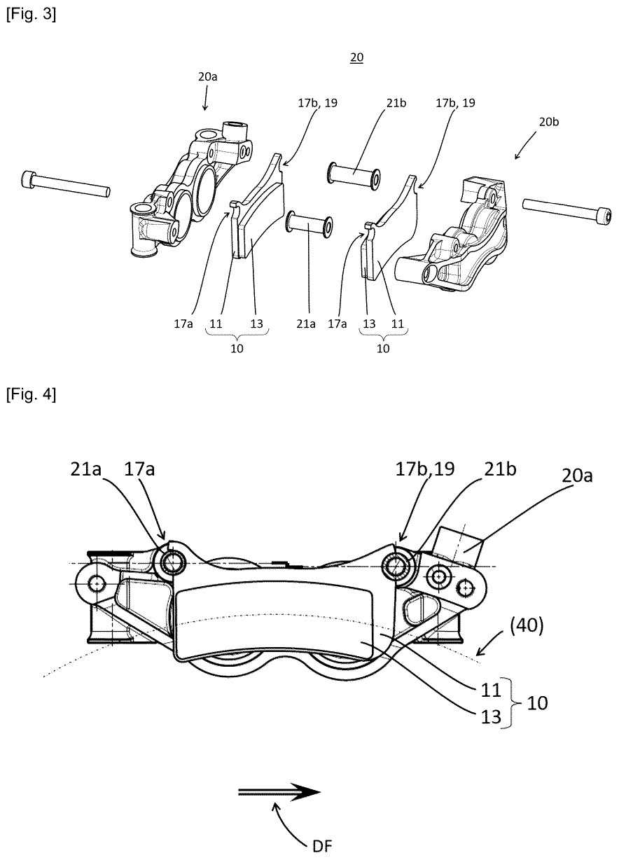

Referring to FIGS. 3 to 6, the pad (10) in the illustrated embodiment is asymmetrical: only one reinforced portion (19) is present, positioned to retain the pad (10) in the braking direction (DF) shown in FIGS. 3 and 6. Since the pads (10) are asymmetrical, they must not be mounted backward on the caliper (20). Thus, there are means of preventing incorrect mounting.

FIGS. 3 and 4 illustrate a first embodiment, in which:
The means of preventing incorrect mounting is a difference between a first mounting diameter and a second mounting diameter;
The reinforced portion (19) is the second diameter, which is larger than the first diameter.

More precisely, the support plate (11) has a first ear (17a) of the first diameter and a second ear (17b) of the second diameter, each ear (17a, 17b) configured to cooperate respectively with a first bushing (21a) of the first diameter and a second bushing (21b) of the second diameter, connecting jaws (20a, 20b) of the caliper (20) and thus creating a sliding connection between the pad (10) and the caliper (20).

Since the second diameter is larger than the first diameter, the surface of the connection bearing significant braking forces is larger. Conversely, the contact pressure is lower, and galling of this surface is prevented.

However, keeping a smaller first diameter allows the use of a smaller, lighter first bushing.

To prevent the first bushing (21a) and the second bushing (21b) from being reversed in the caliper (20), their mounting also incorporates means of preventing incorrect assembly. For example, the first bushing (21a) has a first length, and the second bushing (21b) has a second length different from the first length.

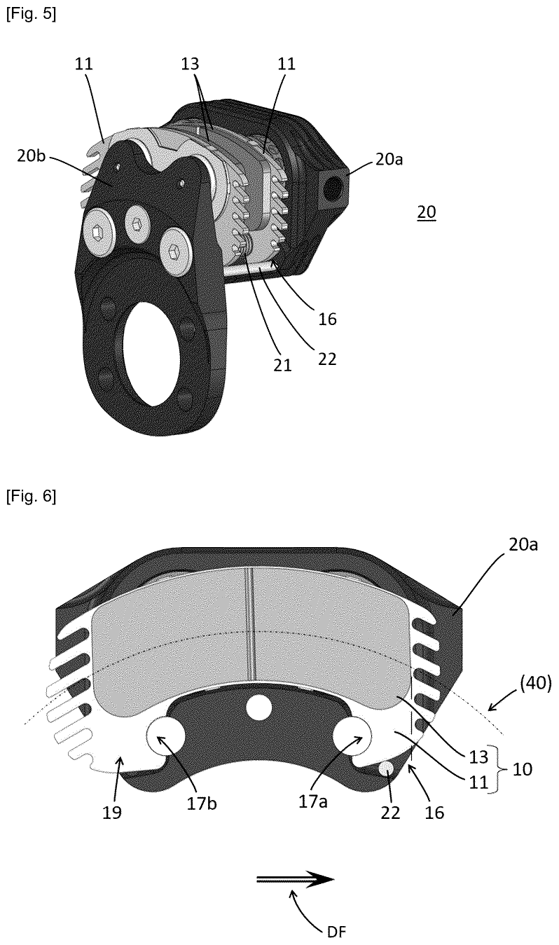

FIGS. 5 and 6 illustrate a second embodiment, in which:
The means of preventing incorrect assembly is an asymmetry of the plate (11), which leaves a passage (16) for a stop (22) of the caliper (20);
The reinforced portion (19) is an enlargement of the dimensions of the plate (11) on the side opposite the passage (16).

The passage (16), in the illustrated form of a bevel, ensures that the stop (22) allows the pad (10) to be mounted only in one direction. This passage (16) is provided on the side of a first ear (17a) of the plate (11), which does not bear significant braking forces due to the direction of the pad (10) mounting.

The reinforced portion (19) is located on the side of a second ear (17b) of the plate, which bears significant braking forces due to its mounting direction.

The reinforced portion (19), in the form of an enlargement of the dimensions, locally increases the moment of inertia of the plate (11), thus preventing its deformation under load. On the side of the first ear (17a), it is not necessary to increase the moment of inertia, so the dimension of the plate is instead reduced.

In this embodiment, the two bushings (21) connecting the jaws (20a, 20b) of the caliper (20) have identical diameters.

The caliper (20) itself has means of preventing incorrect mounting to avoid being mounted backward on the vehicle.

Furthermore, the pad (10), the caliper (20), and the brake (30) can be configured differently from the examples given without departing from the scope of the invention, which is defined by the claims.

Moreover, the technical characteristics of the various embodiments and variants mentioned above can be combined, in whole or in part. Thus, the pad (10), caliper (20), and brake (30) can be adapted in terms of cost, functionality, and performance.

1. Disc (40) for disc brake (30), characterized in that it is made of steel containing less than 0.3% by weight of Carbon.

2. Disc according to claim 1, characterized in that it is made of 18NiCr5-4 steel.

3. Disc according to claim 1, characterized in that it is made of 16NC6 steel.

4. Disc brake (30) receiving a disc (40) according to any one of claims 1 to 3.

5. Disc brake (30) according to claim 4, characterized in that it comprises a caliper (20) equipped with pads (10) comprising a support plate (11) receiving a lining (13), and the support plate (11) is made of low-alloy steel containing less than 0.3% by weight of carbon, preferably less than 0.2%, and vanadium in an amount between 0.2 and 0.3% by weight.

6. Disc brake (30) according to claim 5, characterized in that the support plate (11) has a thickness between 2 and 6 mm.

7. Disc brake (30) according to any one of claims 4 to 6, characterized in that the plate (11) has means of kinematic connection with a caliper (20) of the brake (30), and part of these connection means is configured to withstand greater mechanical forces than the rest of the connection means and takes the form of a reinforced portion (19).

8. Disc brake (30) according to claim 7, characterized in that the support plate (11) has a first ear (17a) of a first diameter and a second ear (17b) of a second diameter larger than the first diameter, and each ear (17a, 17b) is configured to cooperate respectively with a first bushing (21a) and a second bushing (21b) of the caliper (20), creating a sliding connection between the pad (10) and the caliper (20), and the reinforced portion (19) is the second ear (17b).

9. Disc brake (30) according to claim 8, characterized in that the first bushing (21a) has a first length, and the second bushing (21b) has a second length different from the first length, the bushings (21a, 21b) connecting two jaws (20a, 20b) of the caliper (20).

10. Disc brake (30) according to claim 7, characterized in that the support plate (11) has a first ear (17a) and a second ear (17b) configured to cooperate respectively with bushings (21) of a caliper (20) of identical diameters, creating a sliding connection between the pad (10) and the caliper (20), and the reinforced portion (19) is an increase in the dimensions of the plate (11) near the second ear (17b).

11. Disc brake (30) according to claim 10, characterized in that it comprises:
the two bushings (21) connecting two jaws (20a, 20b) of the caliper (20);
two pads (10);
a stop (22);
the support plate (11) has an asymmetric part (16) configured to leave a passage for the stop (22).
